(19) United States
(12) Patent Application Publication
(10) Pub. No.: US 2009/0089169 A1
(43) Pub. Date: Apr. 2, 2009

(54) Event Based Serving

(75) Inventors: Ankur Gupta, Sunnyvale, CA (US); Arvind Saraf, Surat (IN); Navneet Nair, Bangalore (IN); Navneet Singh, Bangalore (IN); Rahul S. Kulkarni, Maharashtra (IN); Ridhima Kedia, Kolkata (IN); Sandesh D. Tawari, Maharashtra (IN)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/237,949

(22) Filed: Sep. 25, 2008

Related U.S. Application Data
(60) Provisional application No. 60/976,184, filed on Sep. 28, 2007.

(51) Int. Cl. G06Q 30/00

(52) U.S. Cl. 705/14

(57) ABSTRACT

Apparatus, system and methods for an event based advertising server are enclosed. Trend data measured over time periods for user queries are measured. A determination is made as to whether an eligibility event for an advertisement has occurred. If an eligibility event is determined to have occurred, eligibility change data for the advertisement is generated. The eligibility change data defines a change to the presentation eligibility of the advertisement and is based on the trend data.

### CROSS-REFERENCE TO RELATED APPLICATIONS

This Application claims priority under 35 U.S.C. §119(e) to U.S. Provisional Application Ser. No. 60/976,184, filed on Sep. 28, 2007, the disclosure of which is incorporated herein by reference.

### BACKGROUND

This document relates to information retrieval.

The rise of the Internet has enabled access to a wide variety of content items, e.g., video and/or audio files, web pages for particular subjects, news articles, etc. Content items of particular interest to a user can be identified by a search engine in response to a user query. One example search engine is the Google search engine provided by Google, Inc. of Mountain View, Calif., U.S.A. The query can include one or more search terms, and the search engine can identify and, optionally, rank the content items based on the search terms in the query and present the content items to the user (e.g., according to the rank). This user query can also be an indicator of the type of information of interest to the user. By comparing the user query to a list of keywords specified by an advertiser, it is possible to provide additional targeted content items, e.g., advertisements, to the user.

Another form of online advertising is ad syndication, which allows advertisers to extend their marketing reach by distributing ads to additional partners. For example, third party online publishers can place an advertiser's text or image ads on web pages that have content related to the advertisement to drive online customers to the advertiser's website.

While the interests of the users may be readily discerned from queries and web pages they are visiting, and advertisements may be selected and served to the users based on these observations, such targeting by advertisers in additional advertising media, such as radio, television and print, is more challenging. The additional advertising media do not readily facilitate the identification of interest signals such as search queries, click-throughs, and conversions, for example.

Additionally, while the advertisements served on-line can be highly effective, the serving of the advertisements can be further optimized by suggesting eligibility changes for an advertisement's presentation eligibility, i.e., parameters that define when and/or where and advertisement should be served. For example, an advertiser may benefit from participating in an advertisement auction at certain times and in certain locations based on environmental data that is external to an advertising campaign, e.g., based on observed user behavior such as search queries trends, or based on the occurrence of entertainment events, e.g., sporting events.

### SUMMARY

Systems, methods and apparatus for event based serving are disclosed. In an implementation, a system includes a data store storing instructions executable by a processing device. The instructions include trend analysis instructions and advertisement eligibility instructions. The trend analysis instructions are configured to cause the processing device to access trend data related to user queries measured over time, and to determine whether an eligibility event for an advertisement has occurred based on the trend data. The advertisement eligibility instructions are configured to cause the processing device to generate change data for the advertisement if the eligibility event is determined to have occurred, the eligibility change data defining a change to a presentation eligibility of the advertisement based on the trend data.

In an implementation, a computer-implemented method accesses trend data measured over time periods for user queries, and determines whether an eligibility event for an advertisement has occurred based on the trend data. If the eligibility event is determined to have occurred, an eligibility change is identified for the advertisement. The identified eligibility defines a change to a presentation eligibility of the advertisement and is based on the trend data.

A computer implemented-method comprises accessing trend data measured over time periods for user queries related to an advertising campaign, generating market suggestions based on the trend data, and adjusting the advertising campaign based on the market suggestions.

A computer-implemented method comprises accessing event trigger data, the event trigger data defining one or more environmental trigger events, and determining whether an eligibility event for an advertisement has occurred based on the event trigger data. If the eligibility event is determined to have occurred, eligibility change data for the advertisement is generated. The eligibility change data defines a change to a presentation eligibility of the advertisement and is based on the event trigger data.

### BRIEF DESCRIPTION OF THE DRAWINGS

FIG. 1 is a block diagram of an example online advertising system.

FIG. 2 is a block diagram of an example event based advertising system.

FIG. 3 is a block diagram of another example event based advertising system.

FIG. 4 is a block diagram of an example event based advertising system process flow.

FIG. 5 is a flow diagram of an example event based ad serving process.

FIG. 6 is a flow diagram of another example event based ad serving process.

FIG. 7 is a flow diagram of another example event based ad serving process.

### DETAILED DESCRIPTION

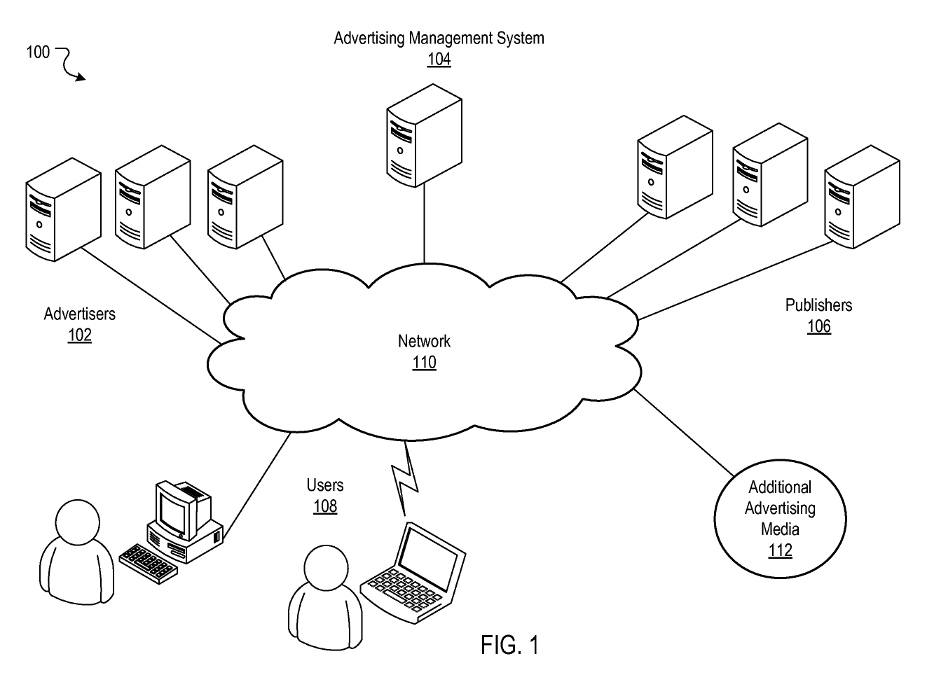

FIG. 1 is a block diagram of an example online advertising system 100. In some implementations, one or more advertisers 102 can directly, or indirectly, enter, maintain, and track advertisement (“ad”) information in an advertising management system 104. Though reference is made to advertising, other forms of content, including other forms of sponsored content, can be delivered by the system 100. The ads may be in the form of graphical ads, such as banner ads, text only ads, image ads, audio ads, video ads, ads combining one or more of any of such components, etc. The ads may also include embedded information, such as links, meta-information, and/or machine executable instructions. One or more publishers 106 may submit requests for ads to the system 104. The system 104 responds by sending ads to the requesting publisher 106 for placement on or association with one or more of the publisher's content items (e.g., web properties). Example web properties can include web pages, television and radio advertising slots, and even print media space.

Other entities, such as users 108 and the advertisers 102, can provide usage information to the system 104, such as, for example, whether or not a conversion or click-through related to an ad has occurred. This usage information can include measured or observed user behavior related to ads that have been served. The system 104 may perform financial transactions, such as crediting the publishers 106 and charging the advertisers 102 based on the usage information.

A computer network 110, such as a local area network (LAN), wide area network (WAN), the Internet, or a combination thereof, connects the advertisers 102, the system 104, the publishers 106, and the users 108.

One example publisher 106 is a general content server that receives requests for content (e.g., articles, discussion threads, music, video, graphics, search results, web page listings, information feeds, etc.), and retrieves the requested content in response to the request. The content server may submit a request for ads to an advertisement server in the system 104. The ad request may include a number of ads desired. The ad request may also include content request information. This information can include the content itself (e.g., page, video broadcast, radio show, or other type of content), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server or a client browser can combine the requested content with one or more of the ads provided by the system 104. The combined content and ads can be sent/rendered to the users 108 that requested the content for presentation in a viewer (e.g., a browser or other content display system). The content server can transmit information about the ads back to the advertisement server, including information describing how, when, and/or where the ads are to be rendered (e.g., in HTML or JavaScript™).

Another example publisher 106 is a search service. A search service can receive queries for search results. In response, the search service can retrieve relevant search results from an index of documents (e.g., from an index of web pages). An exemplary search service is described in the article S. Brin and L. Page, “The Anatomy of a Large-Scale Hypertextual Search Engine,” Seventh International World Wide Web Conference, Brisbane, Australia and in U.S. Pat. No. 6,285,999. Search results can include, for example, lists of web page titles, snippets of text extracted from those web pages, and hypertext links to those web pages, and may be grouped into a predetermined number of (e.g., ten) search results.

The search service can submit a request for ads to the system 104. The request may include a number of ads desired. This number may depend on the search results, the amount of screen or page space occupied by the search results, the size and shape of the ads, etc. In some implementations, the number of desired ads will be from one to ten, or from three to five. The request for ads may also include the query (as entered or parsed), information based on the query (such as geo-location information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from, for example, dot products of feature vectors corresponding to a query and a document, page rank scores, and/or combinations of IR scores and page rank scores, etc.

In one implementation, the advertisement management system 104 may include an auction process to select ads from the advertisers 102. For example, the advertisers 102 may be permitted to select, or bid, an amount the advertisers are willing to pay for each presentation of or interaction with (e.g., click) of an ad, e.g., a cost-per-click amount an advertiser pays when, for example, a user clicks on an ad. The cost-per-click can include a maximum cost-per-click, e.g., the maximum amount the advertiser is willing to pay for each click of an ad based on a keyword, e.g., a word or words in a query. Other bid types, however, can also be used. Based on these bids, ads can be selected and ranked for presentation.

The search service can combine the search results with one or more of the ads provided by the system 104. This combined information can then be forwarded to the users 108 that requested the content. The search results can be maintained as distinct from the ads, so as not to confuse the user between paid ads and presumably neutral search results.

In some implementations, one or more publishers 106 may submit requests for ads to the advertising management system 104. The system 104 responds by sending ads to the requesting publisher 106 for placement on one or more of the publisher's web properties (e.g., websites and other network-distributed content) that are relevant to the web property. For example, if a publisher 106 publishes a sports-related web site, the advertising management system can provide sports-related ads to the publisher 106. In some implementations, the requests can instead be executed by devices associated with the user 108, e.g., by the execution of a javascript when the publishers web page is loading on a client device.

In some implementations, ads can be placed in additional advertising media 112, e.g., advertising media such as radio, television, and even print media. For example, a radio station may communicate with the system 104 over the network 110 to determine and/or receive radio ads that are to be aired. Advertisers 102 can, for example, participate in an advertisement auction to purchase advertisement slots on the radio station. Likewise, a cable system head end may communicate with the system 104 over the network 110, and the advertisers 102 can participate in an advertisement auction to purchase advertisement slots on the television station served by the head end. Similarly, a print publisher may communicate with the system 104 over the network 110, and the advertisers 102 can participate in an advertisement auction to purchase advertisement space in print media published by the publisher.

While the interests of the users 108 may be readily discerned from their queries and ads may be selected and served to the users 108 based on the user queries, such targeting by advertisers 102 in the additional advertising media 112 is more challenging. The additional advertising media 112 do not readily facilitate the identification of interest signals such as search queries, click-throughs, and conversions, for example.

Additionally, while the ads served by the system 104 of FIG. 1 can be highly effective, the serving of the ads can be further optimized by suggesting eligibility changes for an ad's presentation eligibility. For example, an advertiser 102 may benefit from participating in an advertisement auction at certain times and in certain locations based on environmental data that is external to an advertising campaign, e.g., based on observed user behavior such as search query trends, or based on the occurrence of environmental events, e.g., sporting events, breaking news events, weather events, pollen alerts, etc.

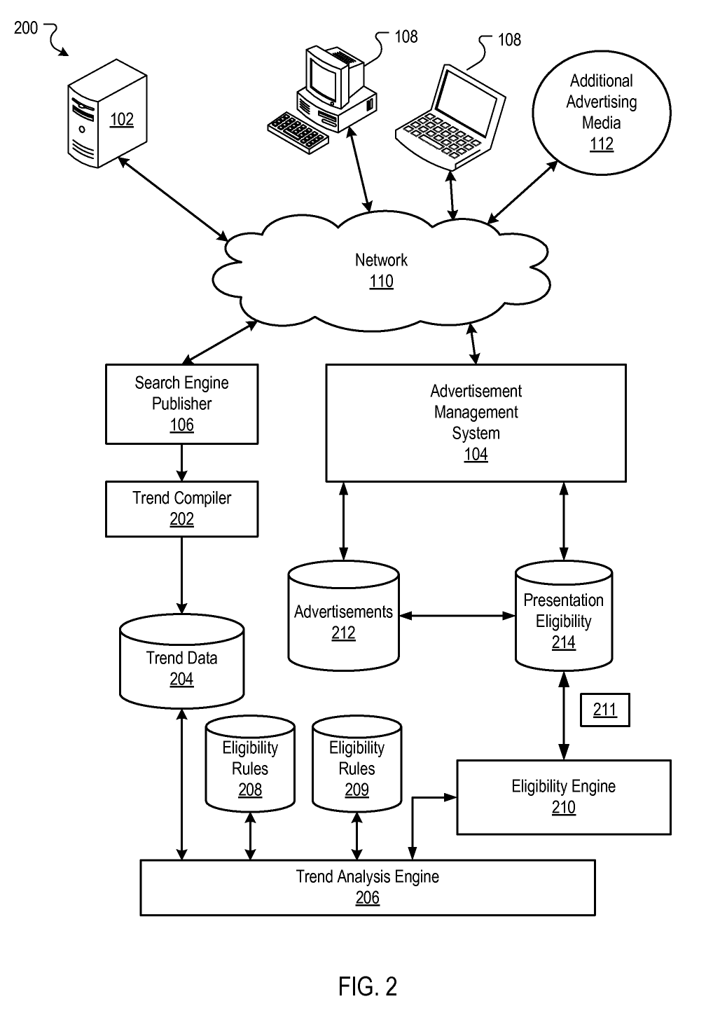

FIG. 2 is a block diagram of an example event based advertising system 200. The system 200 facilitates advertisement targeting of ads served to users 108 and to additional advertising media 112. In an implementation, the system 200 includes a trend compiler 202, a trend analysis engine 206, and an eligibility engine 210. The trend compiler 202 can access query logs and/or receive queries from the publisher search engine 106 and identify query trends and store the query trends as trend data 204.

Presentation eligibility data 214 for ads 212 can be used to define when, where and/or how the ads 212 are to be presented, i.e., to define presentation eligibility. The presentation eligibility data 214 can be, for example, advertising campaign parameters that are modified or adjusted based on an analysis of the trend data 204 against eligibility rules 208. The advertisement management system 104 can access the presentation eligibility data 214 associated with ads 212 and determine which ads to serve.

In some implementations, the presentation eligibility data 214 of the ads 212 is based on a comparison of the trend data 204 to the eligibility rules 208. The trend data 204 can define query trends measured over time and/or geography. For example, the trend data 204 may measure the number or a normalized value indicative of user queries related to a keyword. The trend data 204 may identify a market in which a relative frequency of the user queries in the market exceeds the relative frequency of the user queries in other markets. For example, if Atlanta is a venue for a sporting event, then there may be a high relative frequency of user queries related to that sporting event in Atlanta. The locations determined to have a high relative frequencies of queries that include keywords related to particular ads may be considered markets with a high relative interest in the ads.

In addition to geographic markets, the trend data may define temporal markets. For example, the trend data 204 may identify that the weeks leading up to an event, such as a major sporting event, as having a high relative frequency of user queries that are related to the sporting event. This high relative frequency of user queries can be geographically located, such as near the venue of the sporting event, or may be world wide, e.g., such as a during the World Cup soccer sporting event. Accordingly, the time defined by these periods of high relative frequency for such queries can be identified as temporal markets. For example, the weeks leading up to the World Cup may be identified as markets by the trend data.

In some implementations, the trend data 204 may be compared to the eligibility rules 208 by the trend analysis engine 206 to determine if an eligibility event has occurred. An eligibility event may occur when a rule relating to the presentation of an ad is met. For example, the eligibility rules 208 may require that an ad is only published in geographic markets where user queries for Shoe Brand A exceed user queries for Shoe Brand B. The trend analysis engine 206 may evaluate the eligibility rules 208 by comparing in the trend data 204 for Shoe Brand A against the trend data 204 for Shoe Brand B in the geographic markets.

In some implementations, the eligibility rules 208 may define temporal markets during which advertisements are to be served. For example, a condition for Shoe Brand A advertisements may specify that Shoe Brand A advertisements are only to be displayed when user queries for Shoe Brand A exceed user queries for Shoe Brand B. When the eligibility rules 208 associated with Shoe Brand A are met, an eligibility event regarding the advertisements 212 is determined to have occurred.

In some implementations, when an eligibility event is determined to have occurred by the trend analysis engine 206, the eligibility engine 210 may generate change data 211 to modify the presentation eligibility data 214 of the advertisements 212 associated with the eligibility event. The change data 211 may be used to modify or create restrictions and allowances on the presentation of the advertisements 212. For example, the trend analysis engine 206 may determine that an eligibility event has occurred regarding the presentation of ads for Shoe Brand A in City 1 if City 1 has a higher relative frequency of user queries for Shoe Brand A than any other city. Accordingly, the change data 211 may be used to modify the presentation eligibility data 214 of Shoe Brand A ads to publish more Shoe Brand A ads in City 1 than in other cities.

In some implementations, the change data 211 may modify the presentation eligibility 214 of the advertisements 212 that are part of an advertising campaign. For example, Shoe Brand A Company may have, as part of its Shoe Brand A advertising campaign, ads that have soccer themes and ads that have basketball themes. Additionally, the trend analysis engine 206 may determine that because City 1 has a high relative frequency of user queries for basketball, an eligibility event for Shoe Brand A ads in City 1 has occurred. Based on the eligibility event determination made by the trend analysis engine 206, the change data 211 generated by the eligibility engine 210 may modify all advertisements 212 that are part of the Shoe Brand A advertising campaign. The change data 211 may be used modify the presentation eligibility 214 of ads in the Shoe Brand A advertising campaign to increase the use of basketball themed ads and decrease the use of soccer themed ads.

In some implementations, if an eligibility event occurs, the eligibility engine 210 may issue an alert to an advertiser 102. The alert can include data defining the change in the presentation eligibility of the ad or advertising campaign. In other implementations, the alert may include the markets identified by the trend data to have high relative frequencies of queries related to the advertiser's keywords. The advertiser 102 can then adjust or change the presentation eligibility 214 for its ad or advertising campaign based on the alert. For example, if the trend data 204 indicates that interest in a particular sports team has increased significantly in a city the sports team is visiting, the alert would include suggestions that, if accepted by the advertiser, would update the presentation eligibility 214 to increase the eligibility of ads related to that sports team in that city.

In some implementations, the alert may be issued in the form of email, short message system, instant message or other communication. For example, alert data may be emailed to an advertiser that notifies the advertiser of a market with high relative interest in a particular sports team. The alert data may also be sent to the phone of an advertiser in the form of a text message.

In another implementation, if an eligibility event has occurred, the eligibility engine 210 can automatically change the presentation eligibility data 214 of the advertisements. For example, if the trend data 204 indicates that queries for a particular sports team have increased significantly in a city the sports team is visiting, the eligibility engine 210 can automatically update the presentation eligibility 214 to increase the eligibility of ads related to that sports team in that city.

Based on the presentation eligibility 214 of ads, ads can be more effectively selected over various advertising media, such as the Internet, television, radio, and print. For example, Shoe Brand A may have an advertising campaign with basketball and soccer themed ads for new basketball and soccer shoes. The presentation eligibility data 214 of the ads, determined by a comparison of the trend data 204 with the eligibility rules 208, may suggest that the soccer themed television ads are selected and aired in Atlanta, while the basketball themed television ads are selected and aired in New York. Similarly, newspapers in Atlanta that select Shoe Brand A ads may publish soccer themed ads, while newspapers in New York that select Shoe Brand A ads may publish basketball themed ads.

The trend analysis engine 206 and the eligibility engine 210 can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium. The engines 206 and 210 can be implemented separately, or can be implemented as a single software entity. The engines 206 and 210 can also be distributively implemented over a network, such as a server farm, or can be implemented in a single computer device.

Other implementations to adjust the serving and/or selection of advertisements can also be implemented. For example, in some implementations, a publisher can have associated eligibility rules 209 that can likewise determine what advertisements can be published based on the occurrence of eligibility events indicated by the trend data 204. For example, a sports-related publisher may define eligibility rules 209 that preclude the publishing of football-related equipment advertisements over the publishing of baseball-related equipment advertisements on client devices resolved to geographic locations in which the baseball-related query trends exceed football-related query trends.

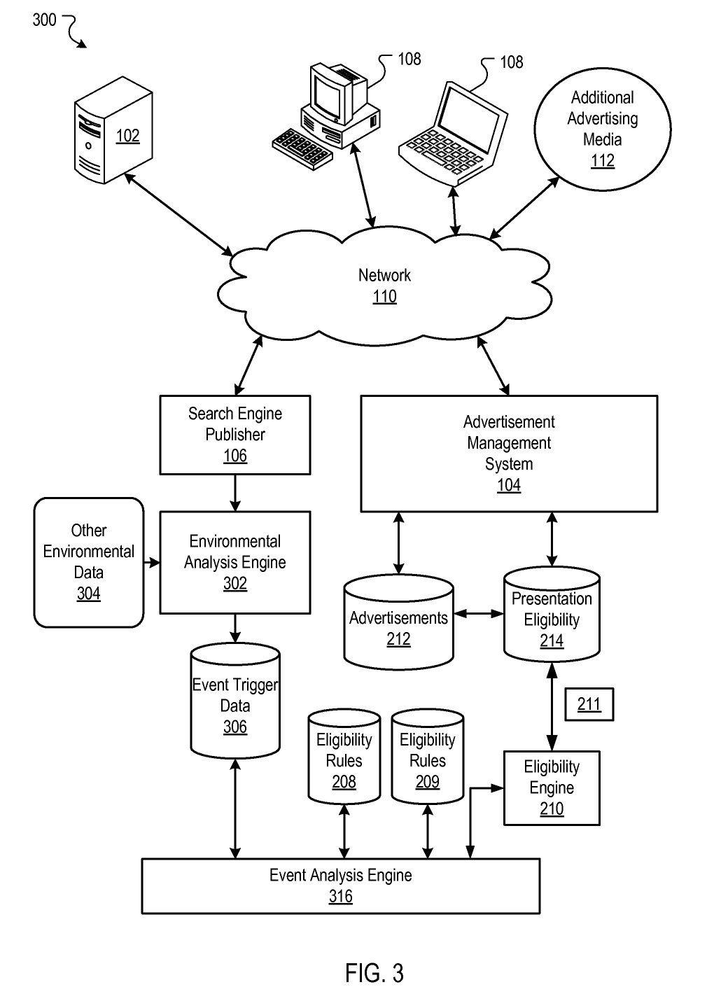

FIG. 3 is a block diagram of another example event based advertising system 300. The system 300 is similar to the system 200 of FIG. 2, except that and environmental analysis engine 302 analyzes other environmental data 304 in addition to user queries. Example environmental data can include data that is external to an advertisement campaign that may affect users. For example, in addition to user queries, the other environmental data 304 can include entertainment event schedules (such as sporting event, concerts, etc.), news events (such as financial market reports, political unrest reports, etc.), weather events (local temperatures, rain forecasts, etc), and other events that may affect users' current and/or long term interests.

The environmental analysis engine 302 can process the environmental data 304 to generate event trigger data 306. The event trigger data 306 can define one or more environmental trigger events. Example environmental trigger events can include user query trends, the occurrence of an entertainment event, the outcome of a sporting event, fluctuations in the financial markets, etc.

In some implementations, the event analysis engine 316 can compare the event trigger data 306 to the eligibility rules 208 to determine if an eligibility event has occurred. An eligibility event may occur when a rule relating to the presentation of an ad is met by a change in the environmental data 304. For example, if the financial markets in the United States suffer a precipitous decline or, alternatively, trend negative for an extended period, the event analysis engine 316 can determine that a declining financial event trigger has occurred. Based on this event trigger, the eligibility engine 210 may create change data 211 to suggest a change to the presentation eligibility 214 of the advertisements 212 so that the advertising campaign of an advertiser, e.g., a brokerage firm, serves, publishes or airs ads related to lower risk investments, such as long term bonds, money market funds, etc.

Conversely, if the financial markets in the United States experience a precipitous increase, or, alternatively, trend positive for an extended period, the event analysis engine 316 can determine that a rising financial event trigger has occurred. Based on this event trigger, the eligibility engine 210 may create change data 211 to suggest a change to the presentation eligibility 214 of the advertisements 212 so that the advertising campaign of an advertiser, e.g., a brokerage firm, serves, publishes or airs ads related to moderate to high-risk investments, such as small cap stocks, emerging market funds, etc.

Thus, based on the presentation eligibility 214 of ads, ads can be more effectively served over various advertising media, such as the Internet, television, radio, and print.

The trend analysis engine 316 and the eligibility engine 210 can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium. The engines 316 and 210 can be implemented separately, or can be implemented as a single software entity. The engines 316 and 210 can also be distributively implemented over a network, such as a server farm, or can be implemented in a single computer device.

Other implementations to adjust the serving and/or selection of advertisements can also be implemented. For example, in some implementations, a publisher can have associated eligibility rules 209 that can likewise determine what advertisements can be published based on the occurrence of eligibility events indicated by the event trigger data 306. For example, a sports-related publisher may define eligibility rules 209 that preclude the publishing of hot weather related product advertisements over the publishing of cold weather related product advertisements on client devices resolved to geographic locations in which the current temperatures are relatively cool. Thus, lightweight running singlet may be advertised on a client device in a geographic location where the temperature is relatively warm, while a running jacket may be advertised on a client device in a geographic location where the temperature is relatively cool.

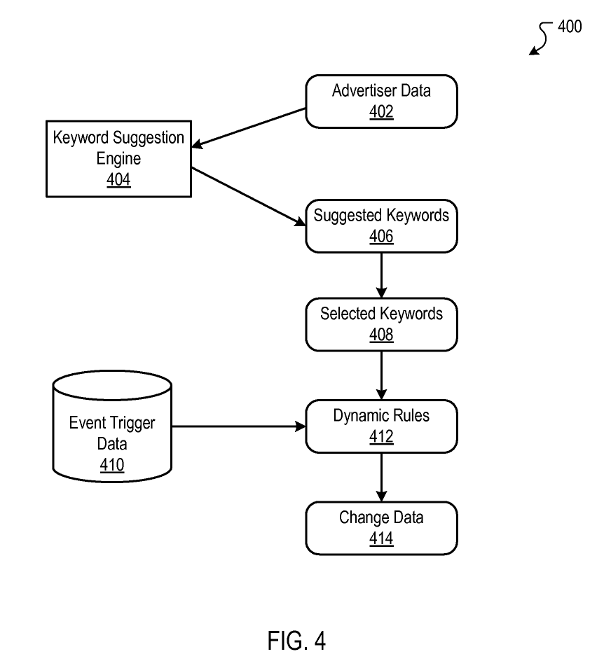

FIG. 4 is a block diagram of an example event based advertising system process flow 400. The process flow 400 illustrates an example process of establishing an event-based advertising campaign.

Advertiser data 402, such as keywords selected by the advertiser, web properties of the advertiser, and/or metadata related to the advertisers products or services are submitted by the advertiser to a keyword suggestion engine 404. The keyword suggestion engine 404 suggests keywords 406 that are relevant to the advertiser data 402. The keyword suggestions can, for example, be based on one or more relevance identification processes, such as term frequency-inverse document frequency (tf-idf) mining, etc.

The advertiser can select keywords 408 from the suggested keywords 406. For example, an advertiser that sells a line of sports drinks related products may enter “Sports Drink” as its advertiser data, or may provide an address of the advertiser's web page to the keyword suggestion engine 404. The suggestion engine 404 may suggest the keywords “Tennis,” “Football,” “carbohydrates,” etc., as keywords that are relevant to the advertiser data. The advertiser may then select “Tennis” and “Football” as the keywords it wishes to use.

Event trigger data 410 associated with the selected keywords 408 may then be compared to the dynamic advertising rules 412, e.g., eligibility rules 210. The dynamic advertising rules 412 may be keyword/query based. In some implementations, the advertiser may define the dynamic rules through a user interface that prompts the advertiser to input responses for advertising related questions, or provides the advertiser with a number of different advertising options, or otherwise facilitates the establishment of the dynamic rules 412. For example, a dynamic rule may be
Trend:tennis[city:New York]>Trend:football[city:New York]
   which is logically true if the query counts for the keyword “tennis” in the city of New York exceed the query counts for the keyword “football” in the city of New York. This information is available by comparing the dynamic advertising rules 412 to the data related to the keywords “tennis” and “football” in the event trigger data 410.

A dynamic advertising rule 412 may also be based on other environmental data. For example, a rule may be
Event:playoffs[city:New York] & sports:football[cityteam:Baltimore] & scheddate:05/01/2008 & sports:event_not_over
   which is logically true if a football playoff game with a team from the city of Baltimore is scheduled to occur in the city of New York on Jan. 5, 2008 and the outcome of the football playoff game has not been decided.

When the dynamic advertising rules 412 for the selected keywords 408 are met, change data 414 may be generated based on the selected keywords 408 and the event trigger data 410. For example, if the dynamic advertising rules 412 for a sports drink indicate that tennis is more popular in New York than football, the sports drink advertiser may adjust a campaign to air more sports drink commercials in a tennis context, and decrease sports drink commercials in a football context. Likewise, if the dynamic advertising rules 412 for a sports drink indicate that a team from Baltimore is scheduled to play a football playoff game in New York on Jan. 5, 2008, the sports drink advertiser may adjust a campaign to air more sports drink commercials in a football context in the cities of Baltimore and New York as long as the dynamic rule is true, i.e., from the time the football playoff game is schedule until the time the game has been decided.

The change data 414 can be an alert issued to an advertiser, or an automatic change to the presentation eligibility data 214. For example, the change data may notify the sports drink advertiser that tennis is more popular than football in New York City. Additionally, the change data may automatically modify the presentation eligibility of the sports drink advertiser's ads for its sports drinks to show more tennis related sports drink ads in New York City.

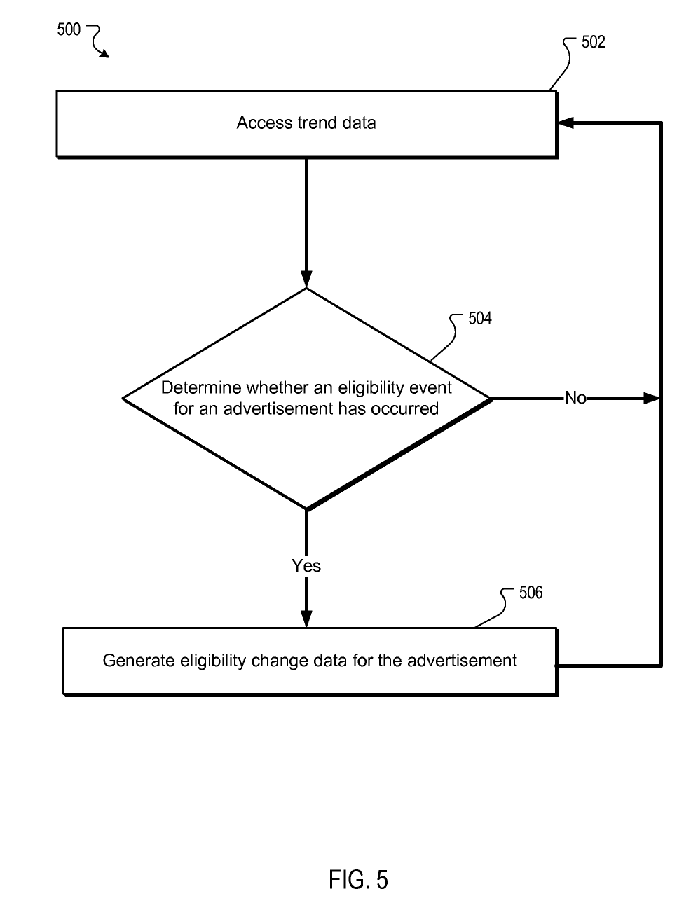

FIG. 5 is a flow diagram of an example event based ad serving process. The process can, for example, be implemented in the event based serving system 200 of FIG. 2 or the event based serving system 300 of FIG. 3.

Stage 502 accesses trend data. For example, the trend analysis engine 206 can access trend data 204 related to user queries.

Stage 504 determines whether an eligibility event for an ad has occurred. For example, the trend analysis engine 206 may determine whether an eligibility event for an ad has occurred. The trend analysis engine 206 may, for example, analyze the trend data 204 and determine that the there is a higher relative frequency of queries relating to a specific car in Los Angeles than there is anywhere in the country. Thus, an eligibility event may have occurred for publication in Los Angeles of advertisements relating to the specific car.

If stage 504 determines that an eligibility event has occurred, stage 506 generates eligibility change data for the ad. For example, stage 504 may determine that an eligibility event has occurred for the advertisements 212 of a specific car in Los Angeles. The eligibility change data may modify the presentation eligibility data 214 of the advertisements 212 to adjust the frequency of publication of the advertisements 212 in Los Angeles. The eligibility change data may take the form of an alert that includes the suggested change to the presentation eligibility and is provided to the advertiser. For example, the specific car advertiser may be notified by an alert that the Los Angeles has a high frequency of queries relating to the specific car being advertised.

If stage 504 determines that an eligibility event has not occurred, the process 500 returns to stage 502. For example, stage 504 may determine that there is no relation between the frequency of the queries and any market for the advertisements 212, thus no eligibility event has occurred for the advertisements 212. The process 500 would return to stage 502 and access trend data. Likewise, stage 506 may return to stage 502 after the eligibility change data for the ad is generated.

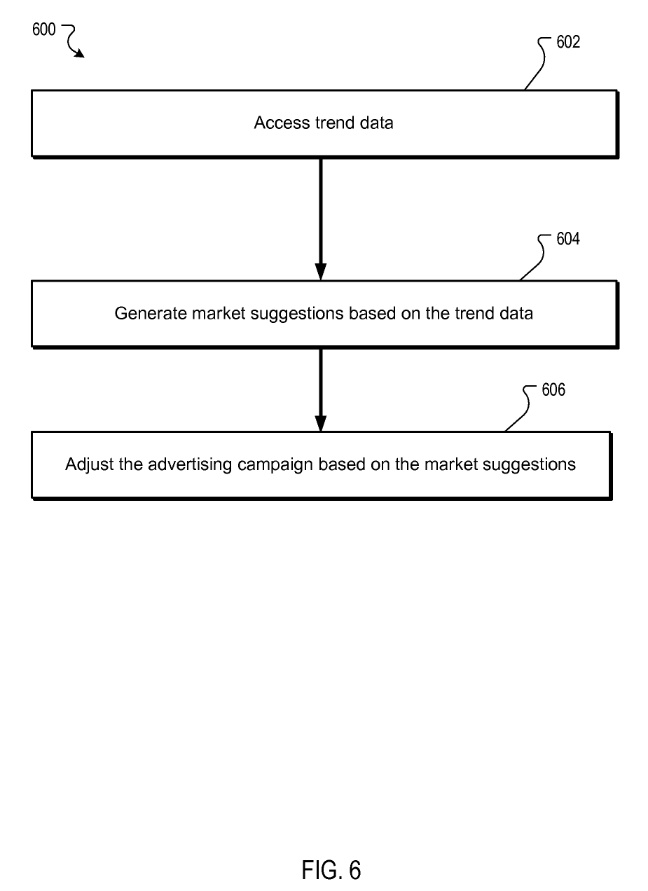

FIG. 6 is a flow diagram of another example event based ad serving process. The process can, for example, be implemented in the event based serving system 200 of FIG. 2 or the event based serving system 300 of FIG. 3.

Stage 602 access trend data. For example, the trend analysis engine 206 can access trend data 204 related to user queries.

Stage 604 generates market suggestions based on the trend data. For example, the trend analysis engine 206 may identify a high relative frequency of queries in the trend data 204 that are in India relating to cricket. Thus, the trend analysis engine 206 may suggest India as a market for cricket related ads. The trend analysis engine may also evaluate the eligibility rules 208 for displaying the advertisements 212 and generate a market suggestion based on the trend data. For example, the eligibility rules 208 may define conditions in which cricket advertisements are only to be displayed when the queries for cricket in any month exceed the queries for cricket in January of 2007. Based on the trend data 204, the trend analysis engine 206 may identify Bangalore, India as a market having a higher relative frequency of keywords related to cricket in the past month compared to relative frequency of those keywords in January 2007.

Stage 606 adjusts the advertising campaign based on the market suggestions. For example, a shoe provider may have cricket based ads and soccer based ads as part of its advertising campaign for its new shoe. Based on the market suggestion generated by the trend analysis engine 206, the eligibility engine 210 may adjust the advertising campaign to publish a higher relative frequency of the shoe provider's cricket based ads in Bangalore, India. The advertising campaign may include internet ads, television ads, radio ads, and other forms of ads.

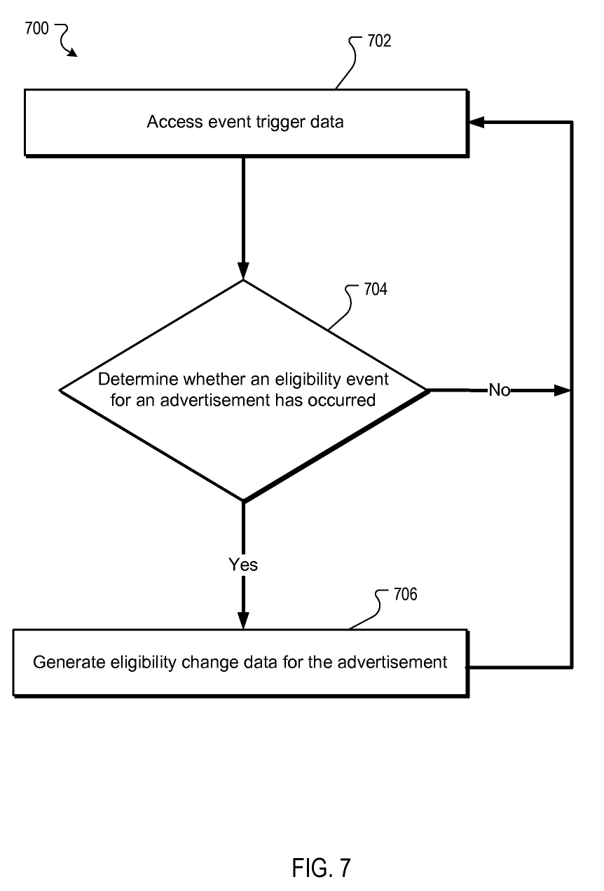

FIG. 7 is a flow diagram of another example event based ad serving process. The process can, for example, be implemented in the event based serving system 200 of FIG. 2 or the event based serving system 300 of FIG. 3.

Stage 702 access event trigger data. For example, the event analysis engine 206 can access event trigger data 306 related to other environmental data 304.

Stage 704 determines whether an eligibility event for an advertisement has occurred. For example, the event analysis engine 316 may analyze the event trigger data 306 and determine that the World Cup is set to begin in one month. Thus, an eligibility event may have occurred for advertisements related to the World Cup.

If stage 704 determines that an eligibility event for an advertisement has occurred, stage 706 generates eligibility change data for the advertisement. For example, stage 704 may determine that an eligibility event occurred for the advertisements 212 related to the World Cup. The eligibility change data may modify the presentation eligibility 214 of the advertisements 212 to adjust the frequency of publication of the advertisements 212 related to the World Cup.

If stage 704 determines that an eligibility event has not occurred, the process 700 returns to stage 702. For example, stage 704 may determine that there is no relation between the event trigger data and any market for the advertisements 212, thus no eligibility event has occurred for the advertisements 212. The process 700 would return to stage 702 and access trend data. Likewise, stage 706 may return to stage 702 after the eligibility change data for the ad is generated.

The apparatus, methods, flow diagrams, and structure block diagrams described in this patent document may be implemented in computer processing systems including program code comprising program instructions that are executable by the computer processing system. Other implementations may also be used. Additionally, the flow diagrams and structure block diagrams described in this patent document, which describe particular methods and/or corresponding acts in support of steps and corresponding functions in support of disclosed structural means, may also be utilized to implement corresponding software structures and algorithms, and equivalents thereof.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A system, comprising:
a data store storing instructions executable by a processing device, the instructions including:
trend analysis engine instructions configured to cause the processing device to access trend data related to user queries measured over time, and to determine whether an eligibility event for an advertisement has occurred based on the trend data; and
advertisement eligibility engine instructions configured to cause the processing device to generate change data for the advertisement if the eligibility event is determined to have occurred, the eligibility change data defining a change to a presentation eligibility of the advertisement based on the trend data.

2. The system of claim 1, further comprising:
an eligibility rule defining one or more trend data conditions associated with an eligibility event; and
wherein the trend analysis engine instructions are configured to determine the eligibility event for an advertisement has occurred if the associated conditions are satisfied.

3. The system of claim 2, wherein the eligibility rule comprises one of a geographically based rule or a temporally based rule.

4. The system of claim 2, wherein the eligibility rule defines a comparison of a keyword associated with the advertisement to the trend data.

5. The system of claim 1, wherein the advertisement eligibility instructions are further configured to cause the processing device to provide the eligibility change data to an advertiser that is associated with the advertisement.

6. The system of claim 1, wherein the wherein advertisement eligibility instructions are further configured to cause the processing device to automatically update the presentation eligibility of the advertisement according to the eligibility change data.

7. A computer-implemented method, comprising:
accessing trend data measured over time periods for user queries;
determining whether an eligibility event for an advertisement has occurred based on the trend data; and
identifying an eligibility change for the advertisement if the eligibility event is determined to have occurred, the identified eligibility change defining a change to a presentation eligibility of the advertisement and based on the trend data.

8. The method of claim 7, further comprising:
generating an alert that includes the identified eligibility change for the advertisement; and
providing the alert to an advertiser associated with the advertisement.

9. The method of claim 7, further comprising automatically changing the presentation eligibility according to the identified eligibility change.

10. The method of claim 7, wherein determining whether an eligibility event for an advertisement has occurred comprises:
identifying a market in which a relative frequency of the user queries in the market exceeds the relative frequency of the user queries in other markets.

11. The method of claim 10, wherein the markets comprise geographic markets.

12. The method of claim 10, wherein the markets comprise temporal markets.

13. The method of claim 10, wherein the identified eligibility change defines a modification of the presentation eligibility of the advertisement in the identified markets.

14. The method of claim 8, wherein providing the alert to an advertiser comprises providing the alert to an advertiser by one or more of email, short message system (SMS), or instant message (IM).

15. The method of claim 7, wherein the advertisement comprises one or more of a television advertisement or radio advertisement.

16. A trend data based advertising system comprising:
means for determining whether an eligibility event for an advertisement has occurred based on trend data; and
means for generating eligibility change data for the advertisement if the eligibility event is determined to have occurred, the eligibility change data defining a change to a presentation eligibility of the advertisement and based on the trend data.

17. A computer implemented-method, comprising:
accessing trend data measured over time periods for user queries related to an advertising campaign;
generating market suggestions based on the trend data; and
adjusting the advertising campaign based on the market suggestions.

18. The method of claim 17, wherein the market suggestions comprises geographic or temporal market suggestions.

19. The method of claim 17, wherein the advertising campaign comprises one or more of a television advertisement or radio advertisement.

20. The method of claim 17, wherein generating market suggestions comprises generating eligibility rules to identify market suggestions from the trend data, the rules defined by a comparison of keywords associated with the advertising campaign to the trend data.

21. A computer-implemented method, comprising:
accessing event trigger data, the event trigger data defining one or more environmental trigger events;
determining whether an eligibility event for an advertisement has occurred based on the event trigger data; and
generating eligibility change data for the advertisement if the eligibility event is determined to have occurred, the eligibility change data defining a change to a presentation eligibility of the advertisement and based on the event trigger data.

22. The method of claim 21, wherein event trigger data comprises user queries, and the environmental trigger events comprise user query trends.

23. The method of claim 21, wherein event trigger data comprises entertainment event schedule data, and the environmental trigger events comprise the occurrence of an event according to the schedule data.

24. The method of claim 21, wherein the advertisement comprises one or more of a television advertisement or radio advertisement.

25. The method of claim 21, further comprising:
an eligibility rule defining one or more trend data conditions associated with an eligibility event; and
wherein the trend analysis instructions are configured to determine the eligibility event for an advertisement has occurred if the associated conditions are satisfied.
